(19) United States
(12) Patent Application Publication
(10) Pub. No.: US 2024/0190773 A1
(43) Pub. Date: Jun. 13, 2024

(54) REFRACTORY PRODUCT HAVING A HIGH CONTENT OF ZIRCONIA

(71) Applicant: SAINT-GOBAIN CENTRE DE RECHERCHES ET D'ETUDES EUROPEEN, COURBEVOIE (FR)

(72) Inventors: Isabelle CABODI, CAVAILLON (FR); Pierrick VESPA, CAVAILLON (FR)

(21) Appl. No.: 18/285,603

(22) PCT Filed: Apr. 7, 2022
(86) PCT No.: PCT/EP2022/059241

§ 371 Date: Oct. 4, 2023

(30) Foreign Application Priority Data
Apr. 7, 2021 (FR) FR2103543

(51) Int. Cl. C04B 35/484; C03B 5/43; C04B 35/657

(52) U.S. Cl. CPC C04B 35/484; C03B 5/43; C04B 35/657; C04B 2235/3201; C04B 2235/3217; C04B 2235/3244; C04B 2235/3409; C04B 2235/3418; C04B 2235/666; C04B 2235/9669

(57) ABSTRACT

Cast molten refractory product comprising, in percentages by weight based on the oxides and for a total of 100%:

| ZrO₂: | complement to 100% |
|---|---|
| HfO₂: | <5% |
| SiO₂: | 8.0% to 11.0% |
| Al₂O₃: | 4.0% to 6.5% |
| Na₂O + K₂O + B₂O₃: | 0.40% to 1.30% |
| B₂O₃: | <0.60% |
| Y₂O₃: | <1.0% |
| Fe₂O₃ + TiO₂: | <0.60% |
| other species: | <1.0% |

with a ratio SiO₂/(Na₂O+K₂O+B₂O₃) less than or equal to 19.0,
the SiO₂ content being greater than or equal to 8.5% if the Al₂O₃ content is greater than or equal to 5.1%.

### TECHNICAL FIELD

The invention relates to a cast refractory product with a high zirconia content, as well as a glass furnace comprising said product.

### PRIOR ART

Glass furnaces generally comprise a very large number of refractory products, arranged at various places depending on their properties. For each part of the furnace, the product selected will be the one that does not cause defects that make the glass unusable (which would reduce the production yields) and is resistant for long enough to give the furnace a satisfactory service life.

Among refractory blocks, a distinction is made between cast blocks and sintered blocks.

In contrast to sintered blocks, cast blocks generally comprise an intergranular vitreous phase joining together the crystalline grains. Therefore the problems posed by sintered blocks and by cast blocks, and the technical solutions adopted for solving them, are generally different.

Therefore a composition developed for making a sintered block is not usable as such a priori for making a cast block, and vice versa.

Cast blocks, often called “electrocast” or “melted and cast”, are obtained by melting a mixture of suitable raw materials in an arc furnace or by any other suitable technique. The molten material is then conventionally cast in a mold, and it then solidifies. Generally, the product obtained then undergoes a controlled cooling cycle so as to be brought to room temperature without fracturing. This operation is called “annealing” by a person skilled in the art.

Cast blocks are known that have very high zirconia content (VHZC), which generally comprise more than 80 wt %, or even more than 85 wt % of zirconia. They have a reputation for very good corrosion resistance and their capacity for not coloring the glass produced and not causing defects in the latter.

EP 403 387 describes cast molten products with a high zirconia content which contain, in percentages by weight, 4 to 5% of SiO₂, about 1% of Al₂O₃, 0.3% of sodium oxide and less than 0.05% of P₂O₅. FR 2 932 475 describes cast molten products with a high zirconia content which contain, in percentages by weight, 3.5 to 6.0% of SiO₂, 0.7 to 1.5% of Al₂O₃, 0.05 to 0.80% of boron oxide B₂O₃, 0.10 to 0.43% of Na₂O+K₂O and less than 0.55% of Fe₂O₃+TiO₂.

Conventionally, the products with very high zirconia content are distinguished from the Alumina-Zirconia-Silica cast products, called “AZS”, whose alumina content is higher and ZrO₂ content is lower. In particular, the AZS products conventionally comprise less than 80 wt % of zirconia. The AZS products also contain corundum (free, or in the form of a corundum/zirconia eutectic) in an amount generally greater than 10%, or above 30%, whereas this phase is generally absent from the VHZC products.

FR2024526A1 essentially describes AZS products for use in a glass furnace tank and states that a content of Al₂O₃ below that of SiO₂ makes it possible to limit cracking and the formation of stones relative to the products in which the Al₂O₃ content is appreciably higher than that of SiO₂.

Cast blocks with very high zirconia content, such as ER 1195 produced and marketed by SEFPRO, are now widely used in glass furnaces. However, the need for glasses of ever better quality and for longer service life of the furnaces means that refractory products are required that are more and more resistant to molten glass, including in increasingly harsh conditions.

The need for these refractory products is particularly critical for certain specific zones of glass furnaces, such as the blocks for glass furnace throats. In contrast to a tank block, a throat block is subjected to a specific environment. The throat blocks are positioned at the outlet of the melting zone, in a zone where the furnace cross section narrows considerably. In this zone, the interface between the molten glass and the refractory product is also horizontal, the glass being positioned under the throat lintel. This interface becomes enriched with elements of the refractory product forming the throat block, which generally increases its density; sedimentation due to gravity is therefore exacerbated by the specific orientation of the refractory products in this zone. In this zone, the refractory products are only in contact with molten glass; any bubbles will therefore rise to the glass/refractory product interface (and not glass/atmosphere as is the case in the tank). The existence of a gas (bubble)—molten glass—refractory product triple point causes an acceleration of corrosion. This particular corrosion, rising to the level of the throat, is called “upward drilling”. Moreover, this zone is generally cooled by a water circuit or by blowing with air. The temperature of the glass/refractory product interface is therefore different than that of the tank, which may lead to differences in behavior which may affect the rate of corrosion. Therefore corrosion is not of the same nature. The existing AZS or VHZC products have insufficient resistance to corrosion in these zones and the refractory products based on chromium oxide cannot be used for all types of glass, in particular the clearest glasses.

For a tank block, we are conventionally interested in corrosion along the line that defines the level of the bath of molten glass, i.e. at the interface between the refractory product, glass and air. It is in fact in this zone that corrosion is much greater. It is therefore the loss of material at the interface that usually determines the end of life of the tank block.

A product that is very suitable for a tank block is not necessarily so for a throat block, and vice versa.

There is a need for refractory products with very high zirconia content having great resistance to molten glass, in particular in the glass furnace throat, while remaining feasible.

### DISCLOSURE OF THE INVENTION

### Summary of the Invention

The invention proposes a cast molten refractory product comprising, in percentages by weight based on the oxides and for a total of 100%:

| ZrO₂: | complement to 100% |
|---|---|
| HfO₂: | <5% |
| SiO₂: | 8.0% to 11.0% |
| Al₂O₃: | 4.0% to 6.5% |
| Na₂O + K₂O + B₂O₃: | 0.40% to 1.30%, preferably less |
| | than or equal to 1.00% |
| B₂O₃: | <0.60% |
| Y₂O₃: | <1.0% |
| Fe₂O₃ + TiO₂: | <0.60% |
| other species: | <1.0% |

with a ratio SiO₂/(Na₂O+K₂O+B₂O₃) less than or equal to 19.0 and preferably greater than or equal to 10.0.

As will be seen in more detail in the rest of the description, this composition endows a cast molten product with remarkable inertness with respect to molten glass. Tests have also shown good feasibility. A product according to the invention is therefore perfectly suited for use in a glass furnace tank or throat.

Preferably, the SiO₂ content is greater than or equal to 8.5% if the Al₂O₃ content is greater than or equal to 5.1%. Remarkably, this characteristic allows industrial manufacture of large blocks, i.e. blocks for which all the overall dimensions are greater than 150 mm.

A product according to the invention may further comprise one or more of the following optional characteristics, including when it conforms to the particular embodiments described hereunder and these optional characteristics are not incompatible with said particular embodiments:
the total porosity of the product is below 10%, or below 5%;
preferably, the oxides represent more than 90%, more than 95%, more than 99%, or even approximately 100% of the weight of the product;
the content by weight of ZrO₂+HfO₂ is below 87.5%, or below 87.0%, or below 86.5%, or below 86.0% and/or above 82.0%, or above 83.0%, or above 83.5%, or above 84.0%;
the content by weight of SiO₂ is below 10.8%, or below 10.6%, or below 10.5%, or below 10.4%, or below 10.3%, or below 10.2%, or below 10.1%, or below 10.0% and/or above 8.1%, preferably above 8.2%, preferably above 8.3%, preferably above 8.4%, preferably greater than or equal to 8.5%, or above 8.6%, or above 8.7%, or above 8.8%, or above 8.9%;
the content by weight of Al₂O₃ is below 6.2%, or below 6.1%, or below 6.0%, or below 5.9%, or below 5.8%, or below 5.7%, or below 5.6% or below 5.5%, or below 5.4%, or below 5.3%, or below 5.2%, or below 5.1% or below 5.0% and/or above 4.1%, or above 4.2%, or above 4.3%, or above 4.4%, or above 4.5%;
the sum of the contents by weight of boron oxide B₂O₃, of sodium oxide Na₂O and of potassium oxide K₂O is preferably above 0.45%, preferably above 0.50%, preferably above 0.55%, preferably above 0.60%, or above 0.65%, or above 0.70%, or above 0.75%, above 0.80%, above 0.85%, above 0.90%, above 0.95 and/or below 1.25%, or below 1.20%, or below 1.15%, or below 1.10%, or below 1.05%, or below 1.00%; the sum of the contents by weight of sodium oxide Na₂O and potassium oxide K₂O is preferably above 0.40%, preferably above 0.45%, preferably above 0.50%, preferably above 0.55%, preferably above 0.60%, or above 0.65%, or above 0.70%, or above 0.75%, above 0.80%, above 0.85%, above 0.90%, above 0.95%, and/or below 1.25%, or below 1.20%, or below 1.15%, or below 1.10%, or below 1.05%, or below 1.00%;
the content by weight of Na₂O is preferably above 0.40%, preferably above 0.45%, or above 0.50%, or above 0.55%, or above 0.60%, or above 0.65%, or above 0.70%, or above 0.75%, or above 0.80%, above 0.85%, above 0.90%, above 0.95%, and/or below 1.25%, or below 1.20%, or below 1.15%, or below 1.10%, or below 1.05%, or below 1.00%;
the content by weight of K₂O is above 0.20%, or above 0.30%, or above 0.40%, or above 0.45%, or above 0.50%, or above 0.55%, or above 0.60%, or above 0.65%, or above 0.70%, or above 0.75%, or above 0.80%; in another embodiment, K₂O is present as impurity or partially replaces Na₂O, and the content by weight of K₂O is below 1.00%, or below 0.90%, or below 0.90%, or below 0.70%, or below 0.60%, or below 0.50%, or below 0.40%, or below 0.30%, or below 0.20%;
B₂O₃ is present as impurity or partially replaces Na₂O, and the content by weight of boron oxide B₂O₃ is below 0.55%, below 0.50%, or below 0.40%, or below 0.30%, or below 0.20%;
the content by weight of Y₂O₃ is below 0.80%, or below 0.60%, or below 0.50%, or below 0.40%, or below 0.30%, or below 0.20%;
the sum of the contents by weight of iron oxide and titanium oxide, Fe₂O₃+TiO₂, is below 0.40%, preferably below 0.30%, preferably below 0.20%;
the total content by weight of the “other species” is below 0.9%, or below 0.8%, or below 0.6%, or below 0.5%, or below 0.4%;
the “other species” consist only of impurities;
the content by weight of any one “other species” is below 0.4%, or below 0.3%, or below 0.2%;
the sum of the contents by weight of calcium oxide CaO, of barium oxide BaO, of strontium oxide SrO and of magnesium oxide MgO is below 0.6%, below 0.5%, below 0.4%, or below 0.3%;
the content by weight of CaO is below 0.4%, or below 0.3%;
the content by weight of BaO is below 0.4%, or below 0.3%;
the content by weight of SrO is below 0.4%, or below 0.3%;
the content by weight of MgO is below 0.4%, or below 0.3%;
the ratio of the contents by weight SiO₂/(Na₂O+K₂O+B₂O₃) is above 10.5, or above 11.0, or above 11.5, or above 12.0 and/or below 18.5, or even below 18.0;
the ratio of the contents by weight SiO₂/Al₂O₃ is above 1.20, or above 1.30, or above 1.40, or above 1.50, or above 1.60 and/or below 2.60, or even below 2.50;
the ratio of the contents by weight Al₂O₃/(Na₂O+K₂O) is below 8.5 and/or above 5.5, or above 6.0;
the content of corundum phase, free, or as corundum/zirconia eutectic, is below 10%, preferably below 5%, preferably below 2%, in percentage by weight.

According to a particular embodiment, the cast molten refractory product according to the invention comprises, in percentages by weight based on the oxides:

| | |
|---|---|
| SiO₂: | 8.5% to 11.0% |
| Al₂O₃: | 4.0% to 6.0% |
| Na₂O + K₂O: | 0.50% to 1.00% |
| B₂O₃: | 0.00% to 0.40%. |

According to a particular embodiment, the cast molten refractory product according to the invention comprises, in percentages by weight based on the oxides:

| | |
|---|---|
| SiO₂: | 8.0% to 9.5% |
| Al₂O₃: | 4.0% to <5.1% |
| Na₂O + K₂O: | 0.50% to 1.10% |
| B₂O₃: | 0.00% to 0.30%. |

According to a particular embodiment, the cast molten refractory product according to the invention comprises, in percentages by weight based on the oxides:

| | |
|---|---|
| SiO₂: | 8.4% to 9.5% |
| Al₂O₃: | 4.0% to <5.1% |
| Na₂O + K₂O: | 0.50% to 1.00% |
| B₂O₃: | 0.00% to 0.30%. |

According to a particular embodiment, the cast molten refractory product according to the invention comprises, in percentages by weight based on the oxides:

| | |
|---|---|
| SiO₂: | 8.5% to 10.5% |
| Al₂O₃: | 4.4% to 5.5% |
| Na₂O + K₂O: | 0.55% to 0.95% |
| B₂O₃: | 0.00% to 0.30%. |

According to a particular embodiment, the cast molten refractory product according to the invention comprises, in percentages by weight based on the oxides:

| | |
|---|---|
| SiO₂: | 8.5% to 10.5% |
| Al₂O₃: | ≥5.1% |
| Na₂O + K₂O: | 0.60% to 1.20% |
| B₂O₃: | 0.00% to 0.30% |

with a ratio SiO₂/(Na₂O+K₂O+B₂O₃) between 10.0 and 19.0.

Preferably,
the SiO₂ content is below 10%, preferably below 9%, preferably below 8.7%, preferably below 8.6%, and above 8.1%, preferably above 8.2%, preferably above 8.3%, preferably above 8.4%, and
the Al₂O₃ content is below 5.1%, preferably below 5.0%, preferably below 4.9%, preferably below 4.8%, preferably below 4.7%, preferably below 4.6%, and above 4.0%, preferably above 4.1%, preferably above 4.2%, preferably above 4.3%, preferably above 4.4%, and
preferably, the ratio of the contents by weight SiO₂/(Na₂O+K₂O+B₂O₃) is greater than or equal to 10.0, preferably above 10.5, preferably above 11.0 and preferably below 15.0, preferably below 14.0, preferably below 13.0, preferably below 12.0.

The invention also relates to a method of manufacture of a refractory product according to the invention, comprising the following successive steps:
a) mixing raw materials so as to form an initial charge,
b) melting said initial charge until molten material is obtained,
c) casting and solidification of said molten material, by cooling, so as to obtain a refractory product,
this method being remarkable in that said raw materials are selected in such a way that said refractory product conforms to the invention.

Preferably, the oxides for which a minimum content is required, or precursors of these oxides, are added systematically and methodically. Preferably, the contents of these oxides are taken into account in the sources of the other oxides, where they are present as impurities.

Preferably, cooling is controlled, preferably so as to be carried out at a rate of less than 20° C. per hour, preferably at a rate of about 10° C. per hour.

The invention also relates to a glass furnace comprising a refractory product according to the invention, or a refractory product manufactured or that could have been manufactured by a method according to the invention, in particular in a zone intended to be in contact with molten glass, in particular in a tank or a throat of the glass furnace.

### Definitions

A product is conventionally called “cast” when it is obtained by a method employing melting of a charge until molten material is obtained, and then solidification of this material by cooling.

A block is an object where all the dimensions are greater than 10 mm, preferably greater than 50 mm, and preferably greater than 100 mm. A block may for example have a parallelepipedal general shape or else a specific shape adapted to its use. In contrast to a layer, a block of a cast molten refractory product is conventionally obtained by a method comprising operations of molding and mold release.

The block made of a product according to the invention may have, after fettling/machining, one, two or three overall dimensions (thickness, length, or width) of at least 150 mm, preferably at least 250 mm, or at least 400 mm, or at least 500 mm, or at least 600 mm, or at least 800 mm or even of at least 1000 mm, and/or less than 2000 mm.

Unless stated otherwise, all the contents of oxides in a product according to the invention are percentages by weight based on the oxides. A content by weight of an oxide of a metallic element refers to the total content of this element expressed in the form of the most stable oxide, according to the usual convention in the industry.

HfO₂ cannot be dissociated chemically from ZrO₂. However, according to the present invention, HfO₂ is not added to the charge deliberately. HfO₂ therefore only denotes traces of hafnium oxide, this oxide always being present naturally in the sources of zirconium oxide at contents generally below 5%, and generally below 2%. In a block according to the invention, the content by weight of HfO₂ is below 5%, preferably below 3%, preferably below 2%. For clarity, the total content of zirconium oxide and of traces of hafnium oxide may be denoted equally well by “ZrO₂” or by “ZrO₂+HfO₂”. Therefore HfO₂ is not included in the “other species”.

“Impurities” means the unavoidable constituents, introduced with the raw materials or resulting from reactions with these constituents. The impurities are not required constituents, but are only tolerated. For example, the compounds forming part of the group of oxides, nitrides, oxynitrides, carbides, oxycarbides, carbonitrides and metallic species of iron, titanium, vanadium and chromium are impurities.

The total porosity, as a percentage, is equal conventionally to 100×(1−the ratio of the geometric density divided by the absolute density).

The geometric density is measured according to standard ISO 5016:1997 or EN 1094-4 and is expressed in g/cm³. Conventionally it is equal to the ratio of the mass of the specimen divided by the apparent volume.

The value of absolute density, expressed in g/cm³, can be measured by dividing the mass of a specimen by the volume of this specimen, ground so as to substantially eliminate porosity.

### BRIEF DESCRIPTION OF THE DRAWINGS

Other features and advantages of the invention will become apparent on reading the detailed description given hereunder and on examining the appended drawing, in which:

FIG. 1 shows a photograph of a product not according to the invention (example 1*); and

FIG. 2 shows a photograph of a product according to the invention (example 4).

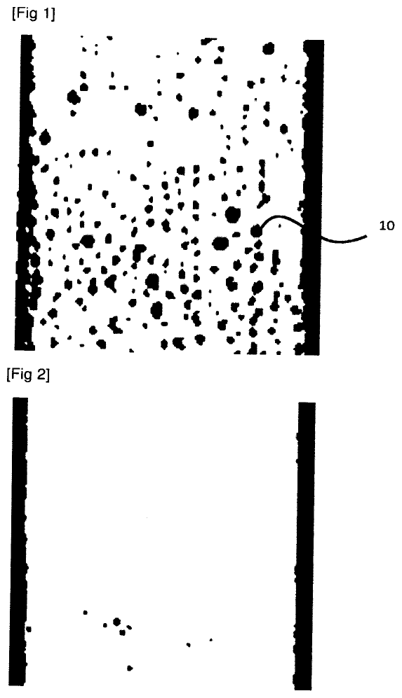

The photographs in FIGS. 1 and 2 have been processed digitally to show up the asperities more clearly.

### DETAILED DESCRIPTION

In the cast molten products according to the invention, the high content of ZrO₂ makes it possible to meet the high requirements for corrosion resistance without generating defects adversely affecting the quality of the glass.

The hafnium oxide, HfO₂, present in the product according to the invention is the hafnium oxide present naturally in the sources of ZrO₂. Its content in a product according to the invention is therefore below 5%, generally below 2%.

The presence of SiO₂ allows in particular the formation of an intergranular vitreous phase capable of effectively accommodating the deformations of the zirconia skeleton. However, the addition of SiO₂ must not exceed 11% as this addition is made to the detriment of the zirconia content and may therefore adversely affect the corrosion resistance.

The presence of Al₂O₃ in the amounts claimed according to the invention is particularly advantageous. Unexpectedly, it makes it possible to reduce, and even prevent the transfer of zirconia from the refractory product to the molten glass. It also ensures good flowability of the molten material in the mold.

The presence of Na₂O+K₂O contributes to the feasibility of the products. The content by weight of Na₂O+K₂O is preferably limited, in order to maintain good resistance to corrosion by the molten glass. In a product according to the invention, the oxides Na₂O and K₂O are considered to have similar effects.

The simultaneous presence of B₂O₃ contributes to the feasibility of the products. However, B₂O₃ has an unfavorable effect on the formation of zircon in the product, which may translate to a harmful effect on the resistance to thermal cycling. The content by weight of boron oxide B₂O₃ must therefore remain limited.

Y₂O₃ may have an unfavorable effect on feasibility. The content by weight of boron oxide Y₂O₃ must therefore remain limited.

In one embodiment, the content of Y₂O₃ is above 0.2%.

According to the invention, the content by weight of Fe₂O₃+TiO₂ is below 0.5%, preferably below 0.3%. Preferably, the content by weight of P₂O₅ is below 0.05%. In fact, these oxides are harmful, in particular for exudation of the refractory products or coloration of the glass and their content must be limited to traces introduced as impurities with the raw materials.

The “other species” are the oxide species that are not listed above, namely the species other than ZrO₂, HfO₂, SiO₂, Al₂O₃, Na₂O, K₂O, B₂O₃, Y₂O₃, TiO₂ and Fe₂O₃. In one embodiment, the “other species” are limited to species whose presence is not particularly desired, and which are generally present as impurities in the raw materials.

Preferably, the product according to the invention is in the form of a block, preferably of a block for which at least one, preferably at least two, preferably all the overall dimensions are greater than 150 mm.

The ratio of the contents by weight SiO₂/(Na₂O+K₂O+B₂O₃) is preferably above 10.0, preferably above 10.5, or above 11.0, or above 11.5, or above 12.0. Such a ratio is particularly advantageous for a tank block. Such a ratio is also particularly advantageous for contents of Al₂O₃ above 5.1%.

The total porosity of the product according to the invention is below 15%, or below 10%, or below 5%, or below 2%, or below 1%.

A product according to the invention may be made conventionally following steps a) to c) described below:
a) mixing raw materials so as to form an initial charge,
b) melting said initial charge until molten material is obtained,
c) solidification of said molten material, by cooling, so as to obtain a refractory product according to the invention.

In step a), the raw materials are selected so as to guarantee the contents of oxides in the end product obtained at the end of step c). A person skilled in the art knows perfectly well how to select the raw materials for this purpose.

In step b), melting is preferably carried out by the combined action of a fairly long electric arc, not causing reduction, and mixing to promote reoxidation of the products.

It is preferable to perform melting in oxidizing conditions for the intended applications.

Preferably the long-arc melting technique described in French patent No. 1 208 577 and its additions No. 75893 and 82310 is used.

This method consists of using an arc furnace, where the arc is struck between the charge and at least one electrode at a distance from this charge, controlling the arc length so that its reducing action is minimized, while maintaining an oxidizing atmosphere above the molten bath and stirring said bath, for example by the action of the arc itself.

In step c), cooling is preferably carried out at a rate of less than 20° C. per hour, preferably at a rate of about 10° C. per hour, preferably in a mold with the desired dimensions, taking into account the gates and risers and optional machining after step c).

Any conventional method of manufacture of cast products based on zirconia intended for applications in glass furnaces may be used, provided that the composition of the initial charge makes it possible to obtain products having a composition conforming to that of a product according to the invention.

In a product according to the invention, ZrO₂ is almost entirely (typically to more than 95% of its weight) in the form of zirconia; SiO₂ and Al₂O₃ are present almost entirely (typically to more than 95% of their weights) in the intergranular phase joining together the crystalline grains of zirconia. This intergranular phase essentially comprises a vitreous phase rich in SiO₂ as well as crystals of mullite.

### EXAMPLES

The following nonlimiting examples are given for the purpose of illustrating the invention.

In these examples, the following raw materials were used:
zirconia Q1 containing on average 99% of ZrO₂+HfO₂,
“Sable BE01 Bédouin” silica containing on average 99% of SiO₂,
alumina of type AC34 containing on average 99% of Al₂O₃,
sodium carbonate containing on average 99.5% of Na₂CO₃ as source of Na₂O,
boron oxide containing on average 98% of B₂O₃.

The products were prepared by the conventional method of melting in an arc furnace, then cast in a mold to obtain blocks of format 150 mm×250 mm×400 mm after fettling.

The chemical analysis of the products obtained is given in Table 1; this is an average chemical analysis, given in percentages by weight. In these examples, K₂O, Y₂O₃ and Fe₂O₃+TiO₂ are optionally present as impurities with K₂O<0.05%, Y₂O₃<0.2% and Fe₂O₃+TiO₂<0.3%.

The other species constitute the complement to 100%.

In Table 1, the content of HfO₂ is always below 5%.

### Feasibility

The external condition of the products obtained is observed. Their size, with the three dimensions greater than 150 mm and at least one dimension of at least 400 mm, makes it possible to estimate industrial feasibility. If a through-crack is present, the feasibility (F) is judged unsatisfactory and designated “0”. The products are then cut in two to observe the filling. In the case of incorrect filling, the feasibility (F) is judged unsatisfactory and designated “0”. Otherwise, the feasibility is judged satisfactory and designated “1”.

### Dissolution of Zirconia

To study the products' ability to resist dissolution of the zirconia by molten glass, skull melting tests were carried out at 1400° C. and 1500° C. to study the interfaces.

A sample of refractory product to be tested is machined to form a cylindrical crucible with outside diameter 50 millimeters, height 50 millimeters, in which a coaxial cylindrical hole of diameter 30 millimeters and height 30 millimeters is made. Soda-lime glass in powder form (with zirconia-free composition) is put in the hole. The crucible thus filled is heated at the specified temperature for 15 hours. After cooling, the crucible is sliced vertically to observe a median section. The median section is polished. The glass/refractory product vertical interface of this polished section is analyzed using microprobe dots to determine the percentage of zirconia in the glass up to 1000 microns from the boundary between the glass and the refractory product. The highest percentage of zirconia (D_Zr) is shown in the table.

### Measurement of Corrosion Resistance in the Throat

The corrosion resistance (CR) is measured on U-shaped specimens obtained from a straight block of length 75 millimeters, width 50 millimeters and height 50 millimeters cut out of the blocks and in which a central groove of width 45 millimeters and height 30 millimeters has been machined. The specimens are immersed (groove downward) in a platinum crucible filled with borosilicate glass in a furnace at 1500° C. or 1550° C. for 200 hours. The loss of thickness of the central part (between the two legs of the U) due to corrosion is measured. The result is given in percent.

### Measurement of Corrosion Resistance in the Tank

The resistance to corrosion by a glass bath with air above is measured on specimens in the form of cylindrical bars of 22 mm diameter and 100 mm height. The specimens are immersed for 48 hours in a bath of molten soda-lime glass, heated to 1500° C. The rotary speed of the specimens was 6 revolutions per minute. At the end of the test, the residual volume of the corroded specimen is measured for each specimen. The residual volume of a corroded specimen of the reference product (example 1) is taken as the basis for comparison. The ratio of the residual volume of any other corroded specimen to the residual volume of the reference corroded specimen, multiplied by 100, gives a corrosion index (CI). Values of CI below 100 represent a larger loss by corrosion than that of the reference product. It is considered here that the corrosion resistance is acceptable for use in a glass furnace tank when the corrosion index CI is greater than or equal to 85, preferably greater than 90.

TABLE 1

| | | | | | | Na₂O + | SiO₂/ | | | | | | |
|---|---|---|---|---|---|---|---|---|---|---|---|---|---|
| | ZrO₂ + | | | Na₂O + | | K₂O + | (B₂O₃ + | | Al₂O₃/ | | | | |
| | HfO₂ | SiO₂ | Al₂O₃ | K₂O | B₂O₃ | B₂O₃ | Na₂O + | SiO₂/ | (Na₂O + | | | CR | |
| | (%) | (%) | (%) | (%) | (%) | (%) | K₂O) | Al₂O₃ | K₂O) | F | D_Zr | (%) | CI |
| 1* | 93.5 | 4.3 | 1.2 | 0.2 | 0.2 | 0.4 | 10.7 | 3.58 | 6.0 | 1 | 15.7 | 2.6 | 100 |
| 2* | 93.0 | 5.2 | 1.5 | 0.2 | 0 | 0.2 | 26.0 | 3.47 | 7.5 | 0 | 10.8 | NT | NT |
| 3* | 84.8 | 9.7 | 3.9 | 0.63 | 0 | 0.63 | 15.5 | 2.52 | 6.2 | 1 | 11.0 | NT | NT |
| 4 | 86.4 | 8.7 | 4.0 | 0.56 | 0 | 0.56 | 15.5 | 2.18 | 7.1 | 1 | NT | 1.8 | NT |
| 5 | 84.0 | 10.3 | 4.1 | 0.69 | 0 | 0.69 | 14.9 | 2.51 | 5.9 | 1 | 7.5 | NT | NT |
| 6 | 86.4 | 8.1 | 4.1 | 0.63 | 0 | 0.63 | 12.9 | 1.98 | 6.5 | 1 | NT | NT | NT |
| 7 | 84.0 | 10.4 | 4.3 | 0.61 | 0 | 0.61 | 17.0 | 2.42 | 7.0 | 1 | 2.3 | 1.4 | 94 |
| 8 | 85.5 | 8.6 | 4.5 | 0.61 | 0 | 0.61 | 14.1 | 1.91 | 7.4 | 1 | NT | NT | NT |
| 9 | 85.3 | 9.2 | 4.5 | 0.75 | 0.04 | 0.79 | 11.7 | 2.04 | 6.0 | 1 | NT | NT | NT |
| 10 | 85.8 | 8.6 | 4.5 | 0.91 | 0.03 | 0.94 | 9.2 | 1.91 | 5.0 | 1 | NT | NT | NT |
| 11 | 85.1 | 8.9 | 4.6 | 0.60 | 0 | 0.60 | 14.8 | 1.93 | 7.7 | 1 | NT | NT | NT |
| 12 | 84.9 | 8.9 | 4.8 | 0.94 | 0.28 | 1.20 | 7.3 | 1.85 | 5.1 | 1 | 4.8 | NT | NT |
| 13 | 85.5 | 8.2 | 4.9 | 0.45 | 0.13 | 0.58 | 14.1 | 1.67 | 10.9 | 1 | NT | NT | NT |
| 14 | 84.3 | 9.5 | 4.9 | 1.00 | 0 | 1.00 | 9.5 | 1.94 | 4.9 | 1 | 2.2 | NT | NT |
| 15 | 84.0 | 9.6 | 5.1 | 0.62 | 0 | 0.62 | 15.5 | 1.88 | 8.2 | 1 | 1.7 | NT | 100 |
| 16* | 85.2 | 8.3 | 5.1 | 0.52 | 0.13 | 0.65 | 12.8 | 1.63 | 9.8 | 0 | NT | NT | NT |
| 17 | 83.8 | 9.7 | 5.1 | 1.19 | 0.03 | 1.22 | 8.0 | 1.90 | 4.3 | 1 | NT | NT | NT |
| 18 | 84.4 | 9.3 | 5.2 | 0.67 | 0 | 0.67 | 13.9 | 1.79 | 7.8 | 1 | NT | 2.0 | NT |
| 19 | 83.0 | 10.5 | 5.2 | 1.12 | 0 | 1.12 | 9.4 | 2.02 | 4.6 | 1 | 2.0 | NT | NT |
| 20 | 83.0 | 10.3 | 5.3 | 1.14 | 0 | 1.14 | 9.0 | 1.94 | 4.6 | 1 | 1.7 | NT | NT |
| 21 | 83.7 | 9.7 | 5.3 | 1.01 | 0 | 1.01 | 9.6 | 1.80 | 5.3 | 1 | 2.0 | NT | NT |
| 22 | 84.4 | 9.3 | 5.4 | 0.77 | 0 | 0.77 | 12.1 | 1.73 | 7.0 | 1 | 2.9 | 0 | NT |
| 23 | 83.0 | 10.2 | 5.4 | 1.13 | 0 | 1.13 | 9.0 | 1.89 | 4.8 | 1 | NT | NT | 81 |
| 24 | 84.5 | 8.8 | 5.6 | 0.49 | 0 | 0.49 | 18.0 | 1.57 | 11.4 | 1 | NT | NT | NT |
| 25 | 84.2 | 8.7 | 5.9 | 0.52 | 0.03 | 0.55 | 15.8 | 1.47 | 11.4 | 1 | NT | NT | NT |
| 26* | 83.9 | 8.7 | 5.9 | 0.33 | 0 | 0.33 | 26.3 | 1.47 | 17.9 | 0 | NT | NT | NT |
| 27* | 80.3 | 11.8 | 6.3 | 0.72 | 0 | 0.72 | 16.4 | 1.87 | 8.8 | 1 | NM | NT | NT |
| 28* | 83.8 | 8.3 | 6.7 | 0.73 | 0 | 0.73 | 11.4 | 1.24 | 9.2 | 0 | NT | NT | NT |

*signifies “not according to the invention”, NT signifies “Not Tested” and NM signifies “Not Measurable”

The tests show that
the alumina content must be sufficient to improve D_Zr;
if the alumina content is too high this leads to degradation of feasibility (example 10*);
a silica content that is too high leads to poor corrosion resistance: in fact, D_Zr could not be measured for example 27* as the glass/refractory product interface was very irregular, indicating poor resistance of the refractory product to corrosion by molten glass;
the content B₂O₃+Na₂O+K₂O, in particular Na₂O+K₂O, in particular Na₂O, must be sufficient and/or the ratio SiO₂/(B₂O₃+Na₂O+K₂O) must be limited to ensure feasibility of the products (comparison of examples 24 or 25 and 26*);
when the Al₂O₃ content is greater than or equal to 5.1%, the SiO₂ content must be sufficient and greater than or equal to 8.5% to ensure feasibility of the products (comparison of example 16* with examples 5 or 18);
when the Al₂O₃ content is greater than or equal to 5.1%, the ratio SiO₂/(B₂O₃+Na₂O+K₂O) must be sufficient for the corrosion resistance CI to allow envisaging use in a glass furnace tank (comparison of examples 23 and 5);
relative to the conventional product, the products according to the invention lead to less dissolution of zirconia in the molten glass while displaying good feasibility.

The corrosion resistance was measured at 1500° C. on a specimen from example 7 (FIG. 2) and on a specimen from example 1* (FIG. 1): the thickness corroded (CR) is 1.4% for example 7 according to the invention whereas it is 2.6% for the product from example 1*.

As illustrated in FIGS. 1 and 2, the example not according to the invention has a surface with a plurality of small craters 10 whereas the example according to the invention is substantially free from them. The product according to the invention thus offers the advantage of giving a very regular corrosion profile.

It can be seen that enrichment of the products with alumina makes it possible to stabilize the composition of the glass at the interface with the glass, and therefore limit renewal of the glass at this interface, and therefore limit the erosion effects of the refractory products.

The corrosion resistance was measured at 1550° C. on a sample from example 22 and on a sample of ER1711 marketed by SEFPRO (typically comprising 41% of ZrO₂, 12% of SiO₂, 45% of Al₂O₃ and 1% of Na₂O) as reference product: the thickness corroded (CR) is 0% for example 22 according to the invention whereas it is 17.4% for the reference product.

As can clearly be seen, the invention therefore supplies a product that gives remarkable performance in the environment of a tank or a throat of a glass furnace.

Of course, the invention is not limited to the embodiments described and presented, supplied purely for purposes of illustration.

1. A cast molten refractory product comprising, in percentages by weight based on the oxides and for a total of 100%:

| ZrO₂: | complement to 100% |
|---|---|
| HfO₂: | <5% |
| SiO₂: | 8.0% to 11.0% |
| Al₂O₃: | 4.0% to 6.5% |
| Na₂O + K₂O + B₂O₃: | 0.40% to 1.30% |
| B₂O₃: | <0.60% |
| Y₂O₃: | <1.0% |
| Fe₂O₃ + TiO₂: | <0.60% |
| other species: | <1.0% |

with a ratio SiO₂/(Na₂O+K₂O+B₂O₃) less than or equal to 19.0,
the SiO₂ content being greater than or equal to 8.5% if the Al₂O₃ content is greater than or equal to 5.1%.

2. The refractory product as claimed in claim 1, in which:
83.0%<ZrO₂+HfO₂<88.0%; and/or
8.4%<SiO₂<10.6%; and/or
3.9%<Al₂O₃<6.1%; and/or
Na₂O+K₂O+B₂O₃≤1.00%; and/or
0.40%<Na₂O+K₂O; and/or
B₂O₃<0.50%; and/or
Y₂O₃<0.40%; and/or
Fe₂O₃+TiO₂<0.40%; and/or
the ratio SiO₂/(Na₂O+K₂O+B₂O₃) is between 10.0 and 19.0.

3. The refractory product as claimed in claim 2, in which:
83.5%<ZrO₂+HfO₂<87.0%; and/or
8.5%<SiO₂<10.5%; and/or
4.0%<Al₂O₃<6.0%; and/or
0.50%<Na₂O+K₂O; and/or
B₂O₃<0.45%; and/or
the ratio SiO₂/(Na₂O+K₂O+B₂O₃) is between 12.0 and 18.0.

4. The refractory product as claimed in claim 1, in which 8.5%≤SiO₂.

5. The refractory product as claimed in claim 1, comprising, in percentages by weight based on the oxides:

| | |
|---|---|
| SiO₂: | 8.5% to 11.0% |
| Al₂O₃: | 4.0% to 6.0% |
| Na₂O + K₂O: | 0.50% to 1.00% |
| B₂O₃: | 0.00% to 0.40%. |

6. The refractory product as claimed in claim 5, comprising, in percentages by weight based on the oxides:

| | |
|---|---|
| SiO₂: | 8.5% to 10.5% |
| Al₂O₃: | 4.4% to 5.5% |
| Na₂O + K₂O: | 0.55% to 0.95% |
| B₂O₃: | 0.00% to 0.30%. |

7. The refractory product as claimed in claim 1, in which the ratio SiO₂/Al₂O₃ is above 1.2 and below 2.6, and/or the ratio Al₂O₃/(Na₂O+K₂O) is below 8.5.

8. The refractory product as claimed in claim 1, in which Al₂O₃<5.1%.

9. The refractory product as claimed in claim 8, in which
the SiO₂ content is below 10% and above 8.1%, and
the Al₂O₃ content is below 5.0% and above 4.0%.

10. The refractory product as claimed in claim 9, in which
the SiO₂ content is below 8.7% and above 8.3%, and
the Al₂O₃ content is below 4.7% and above 4.3%.

11. The refractory product as claimed in claim 1, in which Al₂O₃≥5.1% and the ratio SiO₂/(Na₂O+K₂O+B₂O₃) is greater than or equal to 10.0.

12. The refractory product as claimed in claim 1, having a content by weight of corundum, free or in the form of a corundum/zirconia eutectic, below 5%.

13. A glass furnace comprising a block made of a refractory product as claimed in claim 1.

14. The glass furnace as claimed in claim 1, in which the block is disposed in a tank, the ratio of the contents by weight SiO₂/(Na₂O+K₂O+B₂O₃) being greater than 10.0.

15. The glass furnace as claimed in claim 13, in which the block is disposed in the throat.

16. The glass furnace as claimed in claim 13, in which all the overall dimensions of the block are greater than 150 mm.
